(19) United States
(12) Patent Application Publication
(10) Pub. No.: US 2016/0125384 A1
(43) Pub. Date: May 5, 2016

(54) SYSTEMS AND METHODS TO COORDINATE PROCESSING OF SEPARATE COMPUTING SYSTEMS CONNECTED VIA A COMMUNICATION NETWORK AND HAVING LOCALE DEPENDENT ATTRIBUTES

(71) Applicant: Visa International Service Association, San Francisco, CA (US)

(72) Inventors: Michael Lemberger, Menlo Park, CA (US); Ritu Panchal, Fremont, CA (US); Rajive Gupta, Union City, CA (US); Aravind Babu Ginjupalli, Fremont, CA (US); Raman Chinnappan, Foster City, CA (US); Darpan Dewan, Foster City, CA (US); Lawrence Tsien-Yrun Ho, Foster City, CA (US); Praveen Kumar Prathy, Foster City, CA (US); Todd Sawyer, San Francisco, CA (US); Ann T. Wang Reed, Burlingame, CA (US)

(21) Appl. No.: 14/932,855

(22) Filed: Nov. 4, 2015

Related U.S. Application Data
(60) Provisional application No. 62/075,162, filed on Nov. 4, 2014.

(51) Int. Cl. G06Q 20/32; G06Q 20/38; G06Q 20/40; H04L 29/06; H04L 29/08

(52) U.S. Cl. CPC G06Q 20/325; H04L 67/42; H04L 67/16; H04L 67/22; H04L 67/141; G06Q 20/401; G06Q 20/381

(57) ABSTRACT

A computing apparatus including: a processing system to process a predetermined type of operations using a predetermined communication protocol on a first network connecting a terminal in a first geographical region and a resource controller in a second geographical region; a communication portal to communicate using a second network; and a data store coupled with the processing system. The communication portal communicates via the second network with the mobile device to establish, in the data store, a resource correlation record associating a first resource controlled by the resource controller in the second geographical region with a second resource. The resource correlation record includes locale dependent parameters. In response to a communication initiated in the terminal for an operation of the predetermined type using the first resource, the processing system applies the second resource to the operation in accordance with the resource correlation record using at least the locale dependent parameters.

### RELATED APPLICATIONS

The present application claims the benefit of the filing date of Prov. U.S. Pat. App. Ser. No. 62/075,162, filed the Nov. 4, 2014, the entire disclosure of which application is hereby incorporated herein by reference.

The present application relates to U.S. Pat. App. Pub. No. 2013/0282586, filed Jun. 20, 2013 and U.S. Pat. App. Pub. No. 2013/0246150, filed Mar. 14, 2013, both entitled “Systems and Methods to Apply the Benefit of Offers via a Transaction Handler,” U.S. Pat. App. Pub. No. 2013/0091000, filed Oct. 10, 2012 and entitled “Systems and Methods to Provide Discount at Point of Sales Terminals,” and U.S. Pat. App. Pub. No. 2011/0125565, filed Aug. 3, 2010 and entitled “Systems and Methods for Multi-Channel Offer Redemption,” U.S. Pat. App. Pub. No. 2013/0124287, filed Nov. 14, 2012 and entitled “Systems and Methods to Provide Discount at Point of Sales Terminals,” the entire disclosures of which applications are hereby incorporated herein by reference.

### FIELD OF THE TECHNOLOGY

At least some embodiments disclosed in the present application relate to coordination of a plurality of separate computer systems having separate resources to process a task in general and more particularly but not limited to the use of a communication system to set up the processing of a computing task after a set of predetermined conditions, including a condition related to geographical location, are satisfied.

### BACKGROUND

In a system having multiple computer systems connected via one or more computer networks, resources for processing a task may reside in different computer systems. The use of a predetermined communication protocol allows the computer systems to communicate with each other in a predetermined way to utilize the resources that may be distributed among the computer systems for the processing of the task. Improvements to the communication protocol can improve the performance of the system as a whole and/or improve the functionalities of the system as a whole. In some instances, improvements to the communication protocol can improve the performance of some of the individual computer systems and/or improve the functionalities of the individual computer systems.

For example, a typical electronic payment processing network has a transaction handler interconnecting a plurality of acquirer processors and a plurality of issuer processors according to an electronic communication standard. The transaction handler is generally a special purpose computer system that is substantially independent from other computer systems in the network, such as issuer processors and the acquirer processors, which are special purpose computer systems configured to control accounts from which payments are made and special purpose computer systems configured to control accounts to which the payments are made, respectively.

A typical electronic payment processing network has the capability to process certain transactions, such as credit card or debit card transactions, using a standardized communication protocol, but may not have the capability to process other transactions, such as add-on transactions (e.g., loyalty reward, benefit redemption) coupled with regular transactions.

Some recent developments provided improved electronic payment processing networks that have the improved capability to process certain add-on transactions coupled with conventional electronic payment transactions, such as those disclosed in U.S. Pat. App. Pub. No. 2014/0222533, entitled “Systems and Methods to Use Transaction Authorization Communications to Process Individualized Offers,” U.S. Pat. App. Pub. No. 2013/0282461, entitled “Systems and Methods to Use Transaction Authorization Communications to Process Offers,” U.S. Pat. App. Pub. No. 2013/0246150, entitled “Systems and Methods to Apply the Benefit of Offers via a Transaction Handler,” U.S. Pat. App. Pub. No. 2013/0091000, entitled “Systems and Methods to Provide Discount at Point of Sales Terminals,” U.S. Pat. App. Pub. No. 2013/0124287, entitled “Systems and Methods to Provide Discount at Point of Sales Terminals,” and U.S. Pat. App. Pub. No. 2011/0125565, entitled “Systems and Methods for Multi-Channel Offer Redemption,” the disclosures of which applications are hereby incorporated herein by reference.

There are challenges in implementing the additional capabilities with minimum impact to the performance of the core functionalities of the electronic payment processing network and improving the overall system performances, including interoperability, transaction integrity, efficiency in transaction processing in combination with offers, reduction in time delay in processing and resource allocation, etc.

The disclosures of the above discussed patent documents are hereby incorporated herein by reference.

### BRIEF DESCRIPTION OF THE DRAWINGS

The embodiments are illustrated by way of example and not limitation in the figures of the accompanying drawings in which like references indicate similar elements.

FIG. 1 shows a system having a plurality of separate computing systems disposed in different geographical regions and connected via computer networks to set up and process a computing task according to one embodiment.

FIG. 2 shows a cross-border platform according to one embodiment.

FIG. 3 illustrates a system to provide services based on transaction data according to one embodiment.

FIG. 4 shows a system to provide information based on transaction data according to one embodiment.

FIG. 5 illustrates a transaction terminal according to one embodiment.

FIG. 6 illustrates an account identifying device according to one embodiment.

FIG. 7 illustrates a data processing system according to one embodiment.

### DETAILED DESCRIPTION

In one embodiment disclosed herein, a computing task is configured to be processed by a plurality of separate computing systems disposed in a plurality of different geographical regions (e.g., different countries) that use different resources. The separate computing systems are connected via a centralized processing system using a first network in which a predetermined/standardized communications protocol is used to process computing tasks of predetermined types; and a second network for mobile devices and a communication portal of the processing system provides the communicate connections to set up add-on computing tasks in the processing system, in view of the different resources used in different regions.

In one embodiment, a combination of communications in the first network and communications in the second network is used to set up the computing task.

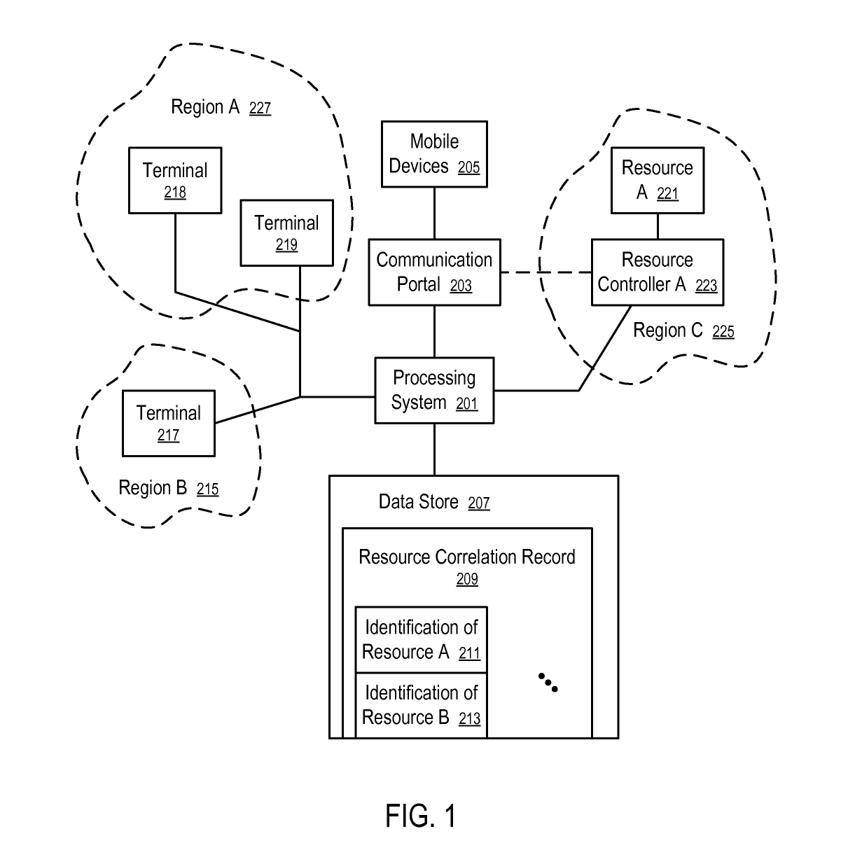

FIG. 1 shows a system having a plurality of separate computing systems disposed in different geographical regions and connected via computer networks to set up and process a computing task according to one embodiment.

In FIG. 1, the separate computing systems includes a centralized processing system (201) and its data store (207) and communication portal (203), mobile devices (205), resource controllers (e.g., 223) and terminals (e.g., 217, 218, . . . , 219).

In one embodiment, the centralized processing system (201) interconnects separate computer systems disposed in different geographical regions, such as the terminals (218, 219) located in region A (227), another terminal (215) located in region B (215), and resource controller A (223) located in region C (225).

In general, the processing system (201) also interconnects other separate computer systems not illustrated in FIG. 1, such as one or more additional resource controllers located in the region C (225) and/or region A (227), or other regions, and one or more additional terminals located in the regions (215, 225, . . . , 227) or other regions. Thus, terminals and resource controllers in the system are not limited to the examples explicitly illustrated in FIG. 1.

In some embodiments, the system may involve more or less regions as illustrated in FIG. 1.

In FIG. 1, a predetermined communication protocol is used to process operations of a predetermined type initiated on terminals (e.g., 217, 218, or 219) using resources (e.g., 221) controlled by resource controllers (e.g., 223). In a typical request in the predetermined communication protocol, a resource is identified for an operation of the predetermined type in the network of the terminals (e.g., 217, 218, or 219) and the resource controllers (e.g., 223) connected by the processing system (201). The processing system (201) facilitates the communications between the relevant terminals (e.g., 217, 218, or 219) and the relevant resource controllers (e.g., 223) based on the predetermined communication protocol.

In FIG. 1, the processing system (201) (or the resource controller A (223)) is coupled with the communication portal (203) that is configured to communicate outside of the network of the terminals (e.g., 217, 218, or 219) and resource controllers (e.g., 223). The communication portal (203) is configured to communicate with the mobile devices (205) (e.g., via internet and/or wireless telecommunications networks) to establish correlation records (e.g., 209) that allow the processing system to bundle the processing tasks, related to the resources (e.g., 221) identified using the predetermined communication protocol, with additional resources, such as a resource controlled by another resource controller, a terminal, etc., without the needs to explicitly identify the additional resources. In some embodiments, the predetermined communication protocol may be insufficient to identify the additional resources.

In FIG. 1, after a detection of a mobile device (205) being in a region (227) (or is about to or plan to enter the region (227)), the communication portal (203) is configured to communicate with the mobile device (205) to establish the resource correlation record (209) that links the identification (211) of the resource A (221) with the identification (213) of resource B such that during the processing of the operation that is requested via the predetermined communication protocol and that requires the resource A (221), an additional resource B identified by the associated identification (213) can be also used in the operation.

In one embodiment, the resource B is controlled by the resource controller A (223) or a different resource controller in the region C (225). In another embodiment, the resource B is controlled by the processing system (201). In a further embodiment, the resource B is controlled by a terminal (e.g., 218) that initiates a relevant operation in which the resource B is to be used.

In one embodiment, a mobile device (205) is associated with the resource A (221); and the location of the mobile device (205) is inferred from the location of a terminal (219) on which an operation requiring the resource A (221) is initiated. For example, after the operation initiated on the terminal (219) disposed in the region A (227) is performed using the resource A (221) in accordance with the predetermined communication protocol, the processing system (201) instructs the communication portal (203) to communicate with the mobile device (205) (e.g., via Internet and/or a wireless telecommunication network) to establish the resource correlation record (209) such that when another terminal (218) disposed in the region (227) subsequently initiates another operation via the communication protocol to use the resource A (221), the resource B identified by the resource correlation record (209) can be used.

In some embodiments, the resource correlation record (209) identifies the terminal (218) such that the resource B is applied only for the operation initiated by the terminal (218) identified in the resource correlation record (209). In some embodiments, the resource correlation record (209) may further identify other conditions that an operation is required to be satisfied in order for the processing system (201) to use the resource B in the processing of the operation.

In one embodiment, the mobile device (205) has a location determination device (e.g., a global positioning system (GPS) receiver) configured to determine the location of the mobile device (205). After the mobile device (205) detects that it has entered the region (227), the mobile device (205) initiates a communication with the communication portal (203) (e.g., via a mobile application running in the mobile device (205)) to establish the resource correlation record (209).

In other embodiments, the mobile device (205) is configured to receive input indicating a planned trip to the region A (227) and in response, initiate a communication with the communication portal (203) to establish the resource correlation record (209).

In further embodiments, the processing system (201) is configured to receive input, in relation with operations on the resource A (221), that indicates the planned trip to the region A (227) and in response, instructs the communication portal (203) to communicate with the mobile device to establish the resource correlation record (209).

In one embodiment, the terminals (e.g., 215, 218, . . . , 219) disposed in different regions have geographically dependent attributes that affect the processing of the operations on the resource A (211) and/or the associated resource B. The resource correlation record (209) not only associates the identification (211) of the resource A (221) and the identification (213) of resource B, but also specifies the parameters for processing the geographically dependent parameters (or locale dependent parameters).

For example, the resource correlation record (209) may store parameters indicative of ways to translate the locale dependent portions of messages from the terminals (e.g., 215, 218, . . . , 219) for forwarding to the relevant resource controller (e.g., 223).

The techniques discussed above in connection with FIG. 1 can be used in many applications, such as the processing of the benefit of an offer during the operations of payment transactions processed in an electronic payment processing network, redemption of reward points during the payment transactions, etc.

For example, in an application of the techniques of FIG. 1, the processing system (201) can be an electronic payment processing network, or a transaction handler of an electronic payment processing network; the resource controller (223) can be an issuer processor; the resource A (221) can be a payment account having funds controlled by the issuer processor; and the terminals (217, 218, . . . , 219) can be transaction terminals configured to initiate payment transactions in the payment accounts, such as a payment account corresponding to the resource A (221).

In one embodiment, the terminals (e.g., 217, 218, . . . , 219) and the resource controllers (e.g., 223) are configured to provide services in different regions (e.g., 215, . . . , 227), such as different countries using different languages, currencies, and/or other communication attributes. The processing system (201) is configured to use the resource correlation record (209) to set up the processing requirements to coordinate the communications involving different region-dependent attributes, such as languages and currencies.

For example, in embodiment, when the mobile device (205) is detected to have entered the region A (227) (e.g., from region C (225)) (or having a planned trip to the region A (227) from the region C (225)), an offer having an application benefit may be communicated to the mobile device (205) to provide an incentive for the user of the mobile device (205) to use the payment account corresponding to the resource A (221) on a terminal (218) to make a payment transaction. In response to the offer being accepted for association with the payment account, the resource correlation record (209) is stored to facilitate the application of the benefit to a payment transaction that satisfies the requirements of the offer, when the payment transaction is initiated via a required terminal (e.g., 218) and transmitted in the electronic payment processing network using a standardized communication protocol for the electronic payment processing network. In one embodiment, the resource correlation record (209) is generated to link the offer as the resource B and the payment account as the resource A (221). In some embodiments, the resource correlation record (209) further includes the parameters for the processing of locale dependent content in communications, such as language, currency, etc., for the processing of the offer.

In one embodiment, the transaction handler is configured to determine whether the transaction in the payment account, as identified in an authorization request that is received from a terminal in the electronic payment processing network, is eligible for the benefit of the offer associated with the payment account, and if so, split the transaction originally requested in the payment account into two or more transactions with an issuer processor of the payment account and one or more sponsor processors of the offer to apply the benefit of the offer to the authorization request for the transaction requested. The two or more transactions are combined for the transaction terminal of the merchant and/or the acquirer processor, such that the details of the two or more transactions are insulated from the transaction terminal and/or the acquirer processor. Thus, a conventional transaction terminal and/or a conventional acquirer processor can be used in the system configured to apply the benefit of an offer during the processing of a transaction initiated and completed at the transaction terminal. Further details and examples can be found in U.S. Pat. App. Pub. No. 2013/0246150, the entire disclosure of which application is hereby incorporated herein by reference.

To facilitate offer redemption via the split-transaction technique as identified above, data associating offers with account information identifying the consumer accounts or payment accounts of the users can be stored in a data warehouse coupled with the transaction handler. For example, in one embodiment of associating offers with consumer/payment accounts, a portal of the transaction handler is configured to store data representing offers, and to associate user selected offers with the financial accounts of the respective users, if the users select messages containing the offers. When the financial accounts are used to make payments processed by the transaction handler for purchases that satisfy the respective redemption conditions of the offers, the transaction handler and/or the portal are configured to detect such payment transactions and fulfill the offers in an automated way, such as in the embodiment of the split-transaction identified above.

For example, a message communicated to a mobile device to present the offer can be configured to have multiple selectable regions when the message is presented in a web browser or a mobile application running in the mobile device. Examples of offers include discounts, incentives, rebates, coupons, rewards, cash back, etc. One of the selectable-regions contains a Uniform Resource Locator (URL) of the advertiser or merchant, which, when selected, directs the user to the website of the advertiser or merchant. A separate one of the selectable regions contains a Uniform Resource Locator (URL) of the portal of the transaction handler, which, when selected, directs the user to the portal for access to a user interface to register the offer with a financial account of the user. Examples of financial accounts of users include credit card accounts, debit card accounts, prepaid card accounts, bank accounts, etc. Some details and examples about associating offers with financial accounts can be found in U.S. Pat. App. Pub. No. 2011/0125565, the entire disclosure of which application is hereby incorporated herein by reference.

After the offer is associated with the financial account of the user, the transaction handler and/or the portal are configured to detect that the user is making a payment using the financial account for a purchase that satisfies the redemption requirements of the offer. In response to the detection, the portal may optionally notify the user of the eligibility of the redemption of the offer using a communication reference associated with the financial account, and the transaction handler and/or the portal are configured to automate the processing of the offer for redemption, such as using the split-payment embodiment identified above, or via statement credits to the financial account of the user, or via benefits afforded via a loyalty program, such as reward points, loyalty points, etc. Some details and examples about offer fulfillment operations can be found in U.S. Pat. App. Pub. No. 2011/0125565, the entire disclosure of which application is hereby incorporated herein by reference.

When an offer is sponsored by the merchant, the transaction handler can be configured in one embodiment to apply the benefit of the registered offer during the authorization and/or settlement of the transaction that meets the requirement for the redemption of the offer via modifying the transaction amount. For example, the authorization amount can be changed by the transaction handler to provide the benefit of the registered offer during the authorization phase of the transaction in one embodiment, and the settlement amount can be changed by the transaction handler to provide the benefit of the registered offer during the settlement phase of the transaction in another embodiment. Some details and examples about redeeming offer benefits via modifying transaction amounts can be found in U.S. Pat. App. Pub. No. 2013/0124287, the entire disclosure of which application is hereby incorporated herein by reference.

In one embodiment, a cross-border platform integrates a web service, an offer engine, a payment processing system that includes financial transaction networks located in different countries. The web service allows users to opt to receive offers. The offer engine is configured to target offers based on the travel activities of the users. The benefits of the offers are configured to be redeemed when the users make payments at merchant systems located in different countries for the purchases of services/products provided by the respective merchants in accordance with the terms and conditions of the offers. The authorization of the payment transactions initiates offer redemption operations that are based on the payment accounts of the users; and a payment processing system interconnects financial transaction networks in different countries to deliver the benefit of the offers. In some embodiments, the offer platform is further configured to perform language translation and currency exchange in message deliveries related to the offers and the fulfillment of the offer benefits.

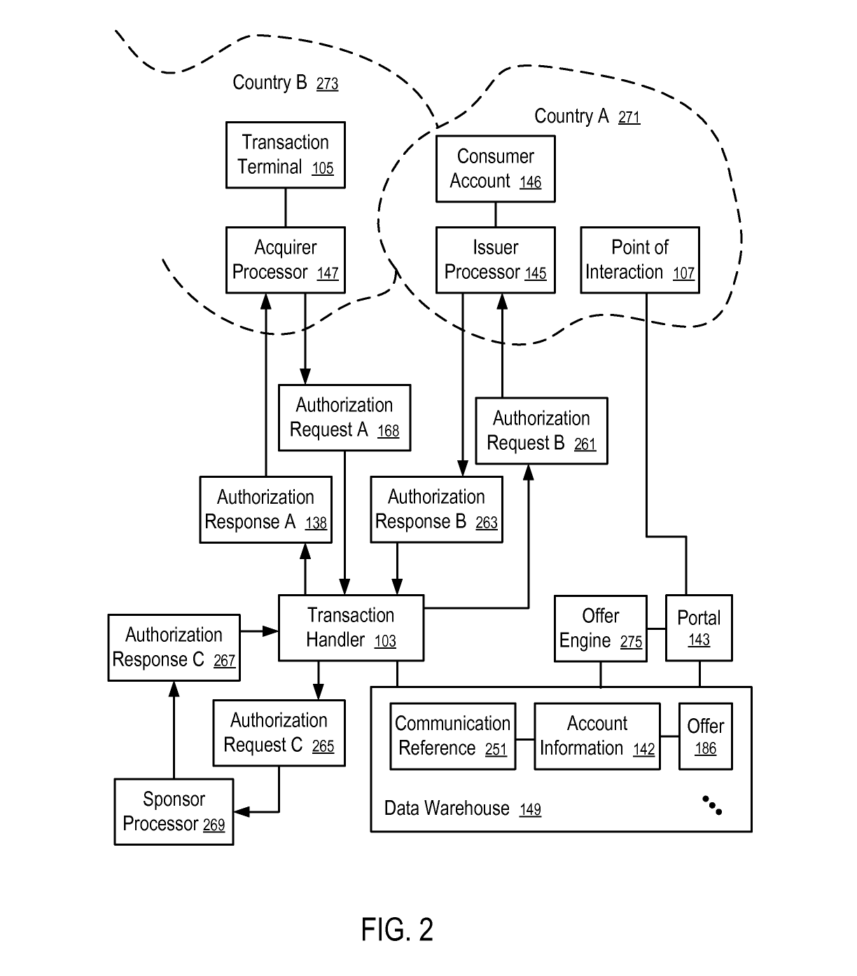

In one embodiment, a cross-border platform is configured to streamline the offer targeting to users planning travels, or traveling, from one country to another. The benefit redemption of the offers is also streamlined for users making purchases using payment accounts aboard in accordance with the requirements of the targeted offers, as illustrated in FIG. 2.

FIG. 2 shows a cross-border platform according to one embodiment. In FIG. 2, the platform includes a portal (143), an offer engine (275), a data warehouse (149), a transaction handler (103) of an electronic payment processing network having the transaction terminals (e.g., 105), acquirer processors (e.g., 147), issuer processors (e.g., 145). The portal (143) is configured to communicate with a point of interaction (107), such as a mobile device (205), outside the electronic payment processing network.

In one embodiment of applying the technique of FIG. 1 in FIG. 2, the transaction handler (103) in FIG. 2 corresponds to the processing system (201) in FIG. 1; the issuer processor (145) corresponds to the resource controller (223); the transaction terminal (105) of FIG. 2 corresponds to the terminal (218) in FIG. 1; the portal (143) of FIG. 2 corresponds to the communication portal (203) of FIG. 1; and the data warehouse (149) of FIG. 2 corresponds to the data store (207) in FIG. 1.

In FIG. 2, the portal (143) is configured to receive, from the point of interaction (107) of a user (101), residing in country A (271), a request to enroll in an offer program supported by the offer platform illustrated in FIG. 2.

After the user (101) is enrolled in the offer program, the system is configured to detect a travel arrangement of the user (101) who plans to travel from country A (271) to country B (273), or has traveled from country A (271) to country B (273).

For example, the transaction handler (103) may monitor the payment transactions of the user (101) to detect the payments for purchasing an airline ticket for a flight from country A (271) to country B (273).

For example, the transaction handler (103) may monitor the payment transactions of the user (101) to detect the authorization request for a hotel reservation in country B (273).

For example, the transaction handler (103) may monitor the payment transactions of the user (101) to detect the authorization request for a hotel reservation in country B (273).

For example, the transaction handler (103) may monitor the payment transactions of the user (101) to detect a travel pattern of the user (101) during certain time periods of the year and predict the travel plan of the user (101).

For example, the portal (143) is configured in one embodiment to present a user interface that allows the user (101) to report the travel arrangement.

For example, a mobile application running on a mobile device (205) as the point of interaction (107) is configured in one embodiment to book the travel arrangement for the user (101) and communicate the travel arrangement of the user (101) to the portal (143).

Upon detecting the travel arrangement of the user (101), the offer engine (275) is configured to select an offer (186) from a merchant in country B (273). In some embodiments, the offer (186) may have one or more requirements that are tailored to the travel arrangement of the user (101).

For example, the redemption of the benefit of the offer (186) may require a purchase paid via the consumer account (146) of the user (101) identified by the account information (142) of the user (101).

For example, the payment transaction for the required purchase may be required to be a card-present transaction in country B (273).

For example, the payment transaction for the required purchase may be required to with a particular merchant operating a transaction terminal (105) in country B (273).

For example, the payment transaction for the required purchase may be required to within a time period that corresponds to the detected travel plan. For example, the offer (186) is configured to expire at time a day before the user (101) returns to country A (271), or after the user (101) returns to country A (271).

In one embodiment, during enrollment in the offer program, the user (101) is prompted to provide the communication reference (251), which is stored in the data warehouse (149) in association with the account information (142) of the user (101). The selected offer (186) is stored in the data warehouse (149) in association with the account information (142) for automated benefit redemption as ways discussed in various sections of the present application.

For example, the benefit of the offer (186) may be provided to the user (101) via a statement credit after the transaction qualifying for the benefit of the offer (186) is settled.

For example, the benefit of the offer (186) may be provided to the user (101) via a reduced transaction amount in the consumer account (146) computed during the authorization of the payment transaction that qualifies for the benefit of the offer (186).

For example, the benefit of the offer (186) may be provided to the user (101) via combining a separate transaction with a sponsor processor (269) and a reduced transaction amount in the consumer account (146) to form a combined transaction with the merchant that includes the payment from both the sponsor processor (269) and the issuer processor of the consumer account (146), during the authorization of the payment transaction that qualifies for the benefit of the offer (186).

In one embodiment, after the offer (186) is selected for the user (101), the portal (143) is configured to transmit a message to the user (101) using the communication reference (251) to inform the user (101) of the offer (186) and the requirements for the redemption of the benefit of the offer (186).

In one embodiment, the message presenting the offer (186) is transmitted at least once to the user (101) while the user (101) is country A (271) or in country B (273).

After the user (101) travels to country B (273), the portal (143) may optionally provide reminders to the user (101) about the offer (186) via the communication reference (251) (e.g., a mobile phone number, an email address, a user identification of a mobile application, a member identification of a social networking site).

While the user (101) in country B (273), the system is configured to monitor the payment transactions associated with the account information (142) to detect a payment transaction between the user and the merchant providing the offer (186) in country B (273).

For example, in FIG. 2, when the user (101) uses the account information (142) to initiate a payment transaction on the transaction terminal (105) of the merchant, the transaction terminal (105) communicates with an acquirer processor (147) of the merchant for the authorization of the payment transaction. In FIG. 2, the acquirer processor (147) is located in country B (273) and in compliance with rules and laws of country B (273).

In one embodiment, the acquirer processor (147) communicates the authorization request (168) for the payment transaction to the transaction handler (103), which may be located in country B (273), country A (271), or a third country.

Based on the authorization request (168) received in the transaction handler (103) from the acquirer processor (147), the transaction handler (103) and/or the offer engine (275) determines whether the payment transaction as requested by the authorization request (168) qualifies for the benefit of the offer (186).

For example, the payment transaction may satisfy a portion of the benefit requirements and the redemption of the benefit of the offer (186) may require a further payment transaction; and thus, the offer engine (275) may store the data to indicate that the portion of the benefit requirements is met in view of the current payment transaction and generates a trigger record to detect the further payment transaction for the redemption of the benefit of the offer (186).

If the offer engine (275) determines that in view of the current payment transaction, the benefit requirements of the offer (186) are completely satisfied, the transaction handler (103) is configured to provide the benefit of the offer (186) to the payment transaction during the authorization of the current payment transaction.

For example, if the benefit of the offer is sponsored by the merchant operating the transaction terminal (105), the transaction handler (103) may adjust the transaction amount in the authorization request (261) transmitted to the issuer processor (145) of the consumer account (146) of the user (101) and/or the transaction amount in the authorization response (138) transmitted back to the acquirer processor (145).

For example, if the benefit of the offer is sponsored by a third party sponsor, the transaction handler (103) is configured to reduce the transaction amount in the authorization request (261) transmitted to the issuer processor (145) in view of the benefit provided by the sponsor processor (269) of the offer (186), and transmit an authorization request (265) to the sponsor processor (269) to obtain a corresponding authorization response (267) from the sponsor processor (269) for the application of the benefit to the current payment transaction. The transaction handler (103) is configured to combine the authorization response (263) from the issuer processor (145) and the authorization response (267) from the sponsor processor (269) to generate a single, combined authorization response (138) for a transaction amount that is the sum of the transaction amount authorized in the authorization response (263) from the issuer processor (145) and the transaction amount authorized in the authorization response (267) from the sponsor processor (269), as if the entire transaction were only in the consumer account (146) controlled by the issuer processor (145).

In one embodiment, the issuer processor (145) is located in country A (271) which has rules and laws for electronic financial transactions different from those in country B (273) in which the acquirer processor (147) is located.

In some embodiments, payment accounts local to different countries are linked to or mapped to international payment accounts for standardized processing by the transaction handler (103), which is configured to bridge the financial transaction networks of different countries and in compliance with the rules of laws of the respective countries.

In one embodiment, the offer engine (275) and/or the portal (143) is further configured to perform language translation for messages delivered to the user (101) via the communication reference (251).

For example, the merchants in country B (273) may specify the message templates using a primary language that is used in country B (273). The message templates are used by the offer engine (275) and/or the portal (143) to present the offers (e.g., 186) to users (e.g., 101), send reminders about the offers to the users, notifying the users of the application of the benefits to the qualified payment transactions during the authorization of the respective payment transactions, etc. When the user (101) is identified to be in the country A (271), the offer engine (275) and/or the portal (143) is configured to translate the messages from the primary language that is used in country B (273) to a preferred language of the user (101) identified in the enrollment of the user (101), or a primary language that is used in country A (273). Thus, the message delivered to the user (101) is customized for the user (101).

In one embodiment, the transaction handler (103) is configured to perform currency exchange among the transaction with the acquirer processor (147), the transaction with the issuer processor (145), and the transaction with the sponsor processor (269), during the fulfillment of the offer benefits and settlement of the transactions.

For example, in one embodiment, the transaction terminal (105) is configured to generate an authorization request (168) that specifies the transaction amount in a currency local to the country B (273). After the transaction handler (103) receives the authorization request (168), the transaction handler (103) converts the transaction amount in the currency local to the country B (273) into the transaction amount in the currency local to the country A (273) based on the location of the issuer processor (145), based on an applicable exchange rate between the currencies. In processing the offer (186), both the transaction amount in the currency local to the country B (273) and the transaction amount in the currency local to the country A (271) can be used.

For example, the offer (186) may specify a requirement for the benefit of the offer (186) in the form of whether or not the transaction amount in the currency local to the country B (273) is above a threshold, and/or whether or not the transaction amount in the currency local to the country A (271) is above a threshold.

For example, the offer (186) may specify the benefit of the offer (186) in the form of a percentage of the transaction amount in the currency local to the country B (273), or a percentage of the transaction amount in the currency local to the country A (271), or a combination of both.

In some embodiments, the offer (186) may specify a predetermined amount of benefits in the currency local to the country B (273), or a predetermined amount of benefits in the currency local to the country A (271), or a combination of both.

In one embodiment, the transaction handler (103) is configured to generate a separate transaction to apply the benefit of the offer (186) as a statement credit to the consumer account (146) identified by the account information (142), in which the transaction handler (103) specifies the benefit of the offer in the currency of the country (271) in which the issuer processor (145) is located.

In one embodiment, the transaction handler (103) is configured to generate a modified authorization request (261) that specifies the transaction amount reduced by the benefit of the offer. When the offer benefit is specified in the currency of country B (273), the transaction handler (103) is configured to provide the authorization request (261) having a field specifying the modified transaction amount in the currency of country B (273) and another field specifying a code identify the currency of country B (273). When the offer benefit is specified in the currency of country A (271), the transaction handler (103) is configured to provide the authorization request (261) having a field specifying the modified transaction amount in the currency of country A (271) and another field specifying a code identify the currency of country A (271). Thus, the currency used in the authorization request B (261) is based on the currency specified for the benefit of the offer (186).

The transaction data, such as records of transactions made via credit accounts, debit accounts, prepaid accounts, bank accounts, stored value accounts and the like, can be further processed to optionally provide information for various services, such as reporting, benchmarking, advertising, content or offer selection, customization, personalization, prioritization, etc. In one embodiment of improving privacy protections, users are required to enroll in a service program and provide consent to allow the system to use related transaction data and/or other data for the related services, and the system is configured to provide the services while protecting the privacy of the users in accordance with the enrollment agreement and user consent.

For example, based on the transaction data, an advertising network in one embodiment is provided to present personalized or targeted advertisements/offers on behalf of advertisers. A computing apparatus of, or associated with, the transaction handler uses the transaction data and/or other data, such as account data, merchant data, search data, social networking data, web data, etc., to develop intelligence information about individual customers, or certain types or groups of customers. The intelligence information can be used to select, identify, generate, adjust, prioritize, and/or personalize advertisements/offers to the customers. The transaction handler may be further automated to process the advertisement fees charged to the advertisers, using the accounts of the advertisers, in response to the advertising activities.

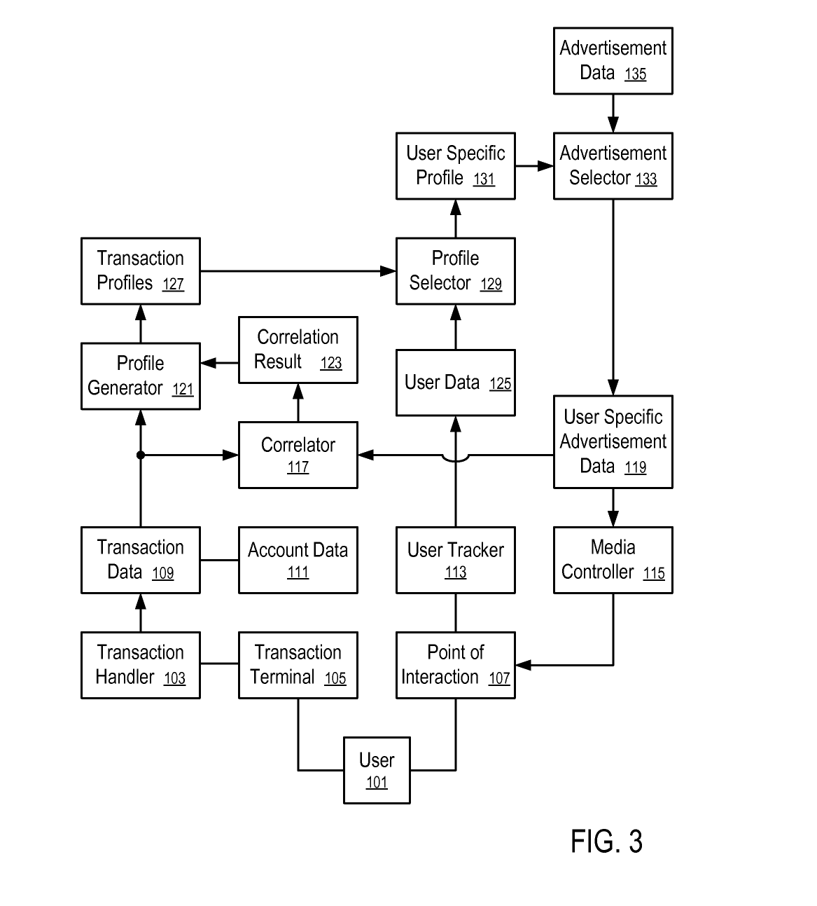

FIG. 3 illustrates a system to provide services based on transaction data according to one embodiment. In FIG. 3, the system includes a transaction terminal (105) to initiate financial transactions for a user (101), a transaction handler (103) to generate transaction data (109) from processing the financial transactions of the user (101) (and the financial transactions of other users), a profile generator (121) to generate transaction profiles (127) based on the transaction data (109) to provide information/intelligence about user preferences and spending patterns, a point of interaction (107) to provide information and/or offers to the user (101), a user tracker (113) to generate user data (125) to identify the user (101) using the point of interaction (107), a profile selector (129) to select a profile (131) specific to the user (101) identified by the user data (125), and an advertisement selector (133) to select, identify, generate, adjust, prioritize and/or personalize advertisements for presentation to the user (101) on the point of interaction (107) via a media controller (115).

In FIG. 3, the system further includes a correlator (117) to correlate user specific advertisement data (119) with transactions resulting from the user specific advertisement data (119). The correlation results (123) can be used by the profile generator (121) to improve the transaction profiles (127).

The transaction profiles (127) of one embodiment are generated from the transaction data (109) via factor analysis and cluster analysis to summarize the spending patterns/behaviors reflected in the transaction records.

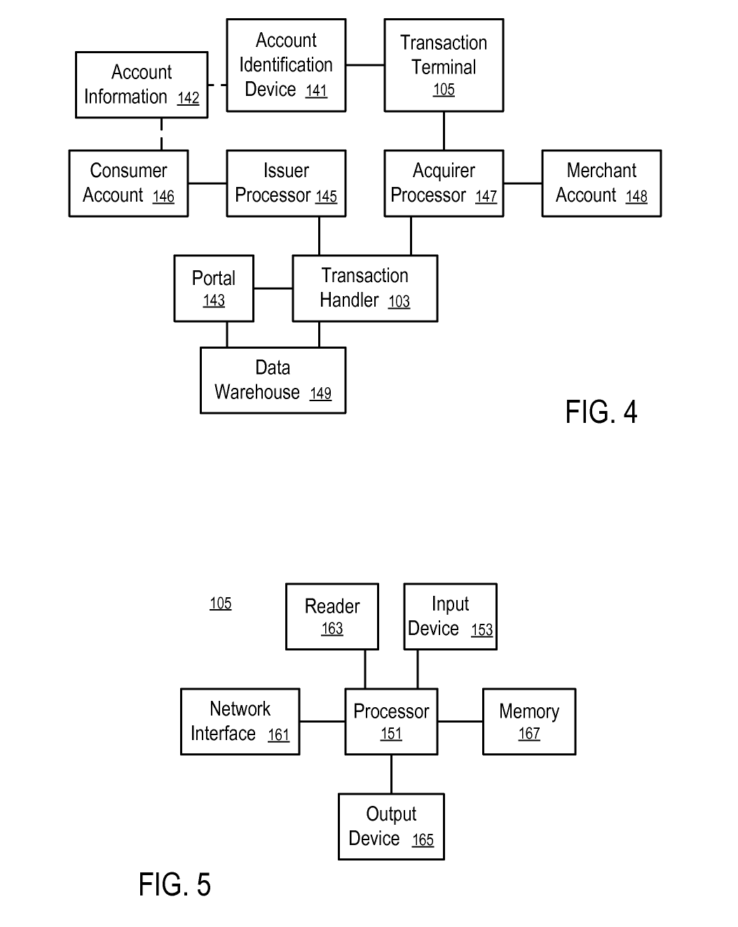

In one embodiment, a data warehouse (149) as illustrated in FIG. 4 is coupled with the transaction handler (103) to store the transaction data (109) and other data, such as account data (111), transaction profiles (127) and correlation results (123). In FIG. 4, a portal (143) is coupled with the data warehouse (149) to provide data or information derived from the transaction data (109), in response to a query request from a third party or as an alert or notification message.

In FIG. 4, the transaction handler (103) is coupled between an issuer processor (145) in control of a consumer account (146) and an acquirer processor (147) in control of a merchant account (148). An account identification device (141) is configured to carry the account information (142) that identifies the consumer account (146) with the issuer processor (145) and provide the account information (142) to the transaction terminal (105) of a merchant to initiate a transaction between the user (101) and the merchant.

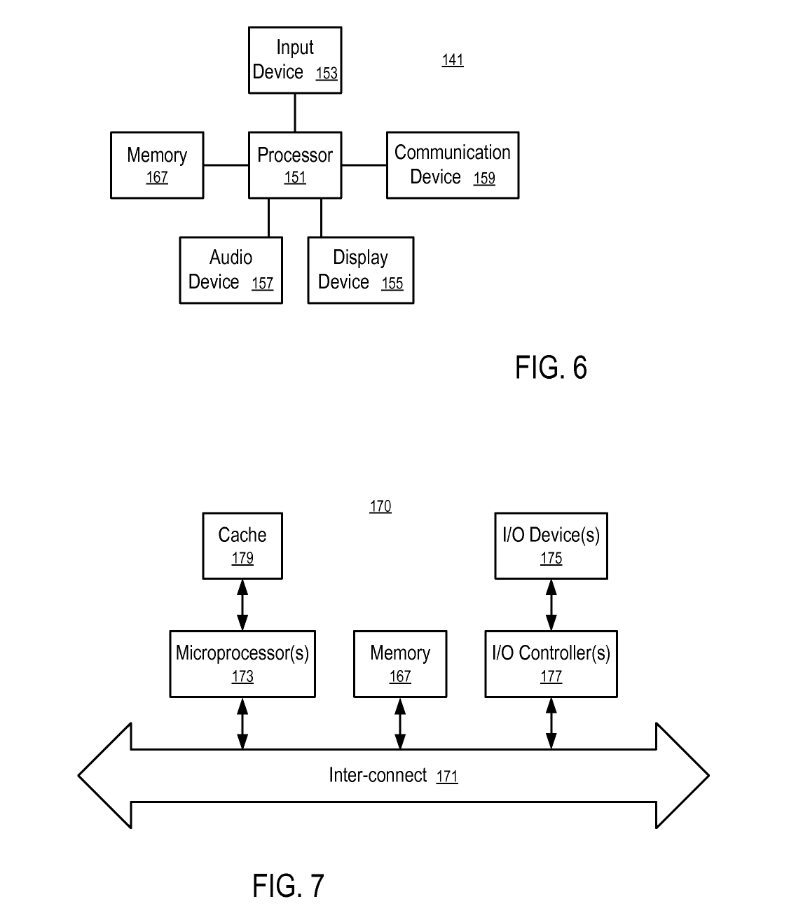

FIGS. 5 and 6 illustrate examples of transaction terminals (105) and account identification devices (141). FIG. 7 illustrates the structure of a data processing system (170) that can be used to implement, with more or fewer elements, at least some of the components in the system, such as the point of interaction (107), the transaction handler (103), the portal (143), the data warehouse, the account identification device (141), the transaction terminal (105), the user tracker (113), the profile generator (121), the profile selector (129), the advertisement selector (133), the media controller (115), etc. Some embodiments use more or fewer components than those illustrated.

In one embodiment, the transaction data (109) relates to financial transactions processed by the transaction handler (103); and the account data (111) relates to information about the account holders involved in the transactions. Further data, such as merchant data that relates to the location, business, products and/or services of the merchants that receive payments from account holders for their purchases, can be used in the generation of the transaction profiles (127).

In one embodiment, the financial transactions are made via an account identification device (141), such as financial transaction cards (e.g., credit cards, debit cards, banking cards, etc.); the financial transaction cards may be embodied in various devices, such as plastic cards, chips, radio frequency identification (RFID) devices, mobile phones, personal digital assistants (PDAs), etc.; and the financial transaction cards may be represented by account identifiers (e.g., account numbers or aliases). In one embodiment, the financial transactions are made via directly using the account information (142), without physically presenting the account identification device (141).

In one embodiment, the transaction handler (103) couples with a centralized data warehouse (149) organized around the transaction data (109). For example, the centralized data warehouse (149) may include, and/or support the determination of, spend band distribution, transaction count and amount, merchant categories, merchant by state, cardholder segmentation by velocity scores, and spending within merchant target, competitive set and cross-section. For example, the centralized data warehouse (149) may include the advertisement data (135) and/or offers of benefits such as discount, reward, points, cashback, etc. The offers can be communicated to the users (e.g., 101) via the advertisement data (135) or as part of the advertisement data (135).

In one embodiment, the centralized data warehouse (149) provides centralized management but allows decentralized execution. For example, a third party strategic marketing analyst, statistician, marketer, promoter, business leader, etc., may access the centralized data warehouse (149) to analyze customer and shopper data, to provide follow-up analyses of customer contributions, to develop propensity models for increased conversion of marketing campaigns, to develop segmentation models for marketing, etc. The centralized data warehouse (149) can be used to manage advertisement campaigns and analyze response profitability.

In one embodiment, the centralized data warehouse (149) includes merchant data (e.g., data about sellers), customer/business data (e.g., data about buyers), and transaction records between sellers and buyers over time. The centralized data warehouse (149) can be used to support corporate sales forecasting, fraud analysis reporting, sales/customer relationship management (CRM) business intelligence, credit risk prediction and analysis, advanced authorization reporting, merchant benchmarking, business intelligence for small business, rewards, etc.

In one embodiment, the transaction data (109) is combined with external data, such as surveys, benchmarks, search engine statistics, demographics, competition information, emails, etc., to flag key events and data values, to set customer, merchant, data or event triggers, and to drive new transactions and new customer contacts.

In FIG. 3, the profile generator (121) generates transaction profiles (127) based on the transaction data (109), the account data (111), and/or other data, such as non-transactional data, wish lists, merchant provided information, address information, information from social network websites, information from credit bureaus, information from search engines, and other examples discussed in U.S. Pat. App. Pub. No. 2011/0054981, entitled “Analyzing Local Non-Transactional Data with Transactional Data in Predictive Models,” the disclosure of which is hereby incorporated herein by reference.

In one embodiment, the transaction profiles (127) provide intelligence information on the behavior, pattern, preference, propensity, tendency, frequency, trend, and budget of the user (101) in making purchases. In one embodiment, the transaction profiles (127) include information about what the user (101) owns, such as points, miles, or other rewards currency, available credit, and received offers, such as coupons loaded into the accounts of the user (101). In one embodiment, the transaction profiles (127) include information based on past offer/coupon redemption patterns. In one embodiment, the transaction profiles (127) include information on shopping patterns in retail stores as well as online, including frequency of shopping, amount spent in each shopping trip, distance of merchant location (retail) from the address of the account holder(s), etc.

In one embodiment, the transaction handler (103) (and/or the portal (143)) is configured to provide at least part of the intelligence for the prioritization, generation, selection, customization and/or adjustment of the advertisement for delivery within a transaction process involving the transaction handler (103). For example, the advertisement may be presented to a customer in response to the customer making a payment via the transaction handler (103).

Some of the transaction profiles (127) are specific to the user (101), or to an account of the user (101), or to a group of users of which the user (101) is a member, such as a household, family, company, neighborhood, city, or group identified by certain characteristics related to online activities, offline purchase activities, merchant propensity, etc.

The profile generator (121) may generate and update the transaction profiles (127) in batch mode periodically, or generates the transaction profiles (127) in real time, or just in time, in response to a request received in the portal (143) for such profiles.

The transaction profiles (127) of one embodiment include the values for a set of parameters. Computing the values of the parameters may involve counting transactions that meet one or more criteria, and/or building a statistically-based model in which one or more calculated values or transformed values are put into a statistical algorithm that weights each value to optimize its collective predictiveness for various predetermined purposes.

Further details and examples about the transaction profiles (127) in one embodiment can be found in U.S. Pat. App. Pub. Nos. 2010/0306032 and 2010/0306029, the entire disclosures of which applications are hereby incorporated herein by reference.

### Transaction Processing

FIG. 4 shows a system to provide information and/or services based on transaction data (109) according to one embodiment.

In FIG. 4, the transaction handler (103) is coupled between an issuer processor (145) and an acquirer processor (147) to facilitate authorization and settlement of transactions between a consumer account (146) and a merchant account (148). The transaction handler (103) records the transactions in the data warehouse (149). The portal (143) is coupled to the data warehouse (149) to provide information based on the transaction records, such as the transaction profiles (127), aggregated spending profile, offer redemption notification, etc. The portal (143) may be implemented as a web portal, a telephone gateway, a file/data server, etc.

In FIG. 4, the transaction terminal (105) initiates the transaction for a user (101) (e.g., a customer) for processing by a transaction handler (103). The transaction handler (103) processes the transaction and stores transaction data (109) about the transaction, in connection with account data (111), such as the account profile of an account of the user (101). The account data (111) may further include data about the user (101), collected from issuers or merchants, and/or other sources, such as social networks, credit bureaus, merchant provided information, address information, etc. In one embodiment, a transaction may be initiated by a server (e.g., based on a stored schedule for recurrent payments).

The accumulated transaction data (109) and the corresponding account data (111) can be used to generate intelligence information about the purchase behavior, pattern, preference, tendency, frequency, trend, amount and/or propensity of the users (e.g., 101), as individuals or as a member of a group. The intelligence information can then be used to generate, identify and/or select targeted advertisements for presentation to the user (101) on the point of interaction (107), during a transaction, after a transaction, or when other opportunities arise.

In FIG. 4, the consumer account (146) is under the control of the issuer processor (145). The consumer account (146) may be owned by an individual, or an organization such as a business, a school, etc. The consumer account (146) may be a credit account, a debit account, or a stored value account. The issuer may provide the consumer (e.g., user (101)) an account identification device (141) to identify the consumer account (146) using the account information (142). The respective consumer of the account (146) can be called an account holder or a cardholder, even when the consumer is not physically issued a card, or the account identification device (141), in one embodiment. The issuer processor (145) is to charge the consumer account (146) to pay for purchases.

The account identification device (141) of one embodiment is a plastic card having a magnetic strip storing account information (142) identifying the consumer account (146) and/or the issuer processor (145). Alternatively, the account identification device (141) is a smartcard having an integrated circuit chip storing at least the account information (142). The account identification device (141) may optionally include a mobile phone having an integrated smartcard.

The account information (142) may be printed or embossed on the account identification device (141). The account information (142) may be printed as a bar code to allow the transaction terminal (105) to read the information via an optical scanner. The account information (142) may be stored in a memory of the account identification device (141) and configured to be read via wireless, contactless communications, such as near field communications via magnetic field coupling, infrared communications, or radio frequency communications. Alternatively, the transaction terminal (105) may require contact with the account identification device (141) to read the account information (142) (e.g., by reading the magnetic strip of a card with a magnetic strip reader).

The transaction terminal (105) is configured to transmit an authorization request message to the acquirer processor (147). The authorization request includes the account information (142), an amount of payment, and information about the merchant (e.g., an indication of the merchant account (148)). The acquirer processor (147) requests the transaction handler (103) to process the authorization request, based on the account information (142) received in the transaction terminal (105). The transaction handler (103) routes the authorization request to the issuer processor (145) and may process and respond to the authorization request when the issuer processor (145) is not available. The issuer processor (145) determines whether to authorize the transaction based at least in part on a balance of the consumer account (146).

The transaction handler (103), the issuer processor (145), and the acquirer processor (147) may each include a subsystem to identify the risk in the transaction and may reject the transaction based on the risk assessment.

The account identification device (141) may include security features to prevent unauthorized uses of the consumer account (146), such as a logo to show the authenticity of the account identification device (141), encryption to protect the account information (142), etc.

The transaction terminal (105) of one embodiment is configured to interact with the account identification device (141) to obtain the account information (142) that identifies the consumer account (146) and/or the issuer processor (145). The transaction terminal (105) communicates with the acquirer processor (147) that controls the merchant account (148) of a merchant. The transaction terminal (105) may communicate with the acquirer processor (147) via a data communication connection, such as a telephone connection, an Internet connection, etc. The acquirer processor (147) is to collect payments into the merchant account (148) on behalf of the merchant.

In one embodiment, the transaction terminal (105) is a POS terminal at a traditional, offline, “brick and mortar” retail store. In another embodiment, the transaction terminal (105) is an online server that receives account information (142) of the consumer account (146) from the user (101) through a web connection. In one embodiment, the user (101) may provide account information (142) through a telephone call, via verbal communications with a representative of the merchant; and the representative enters the account information (142) into the transaction terminal (105) to initiate the transaction.

In one embodiment, the account information (142) can be entered directly into the transaction terminal (105) to make payment from the consumer account (146), without having to physically present the account identification device (141). When a transaction is initiated without physically presenting an account identification device (141), the transaction is classified as a “card-not-present” (CNP) transaction.

In general, the issuer processor (145) may control more than one consumer account (146); the acquirer processor (147) may control more than one merchant account (148); and the transaction handler (103) is connected between a plurality of issuer processors (e.g., 145) and a plurality of acquirer processors (e.g., 147). An entity (e.g., bank) may operate both an issuer processor (145) and an acquirer processor (147).

In one embodiment, the transaction handler (103), the issuer processor (145), the acquirer processor (147), the transaction terminal (105), the portal (143), and other devices and/or services accessing the portal (143) are connected via communications networks, such as local area networks, cellular telecommunications networks, wireless wide area networks, wireless local area networks, an intranet, and Internet. Dedicated communication channels may be used between the transaction handler (103) and the issuer processor (145), between the transaction handler (103) and the acquirer processor (147), and/or between the portal (143) and the transaction handler (103).

In FIG. 4, the transaction handler (103) uses the data warehouse (149) to store the records about the transactions, such as the transaction records or transaction data (109).

Typically, the transaction handler (103) is implemented using a powerful computer, or cluster of computers functioning as a unit, controlled by instructions stored on a computer readable medium. The transaction handler (103) is configured to support and deliver authorization services, exception file services, and clearing and settlement services. The transaction handler (103) has a subsystem to process authorization requests and another subsystem to perform clearing and settlement services. The transaction handler (103) is configured to process different types of transactions, such credit card transactions, debit card transactions, prepaid card transactions, and other types of commercial transactions. The transaction handler (103) interconnects the issuer processors (e.g., 145) and the acquirer processor (e.g., 147) to facilitate payment communications.

In FIG. 4, the transaction terminal (105) is configured to submit the authorized transactions to the acquirer processor (147) for settlement. The amount for the settlement may be different from the amount specified in the authorization request. The transaction handler (103) is coupled between the issuer processor (145) and the acquirer processor (147) to facilitate the clearing and settling of the transaction. Clearing includes the exchange of financial information between the issuer processor (145) and the acquirer processor (147); and settlement includes the exchange of funds.

In FIG. 4, the issuer processor (145) is configured to provide funds to make payments on behalf of the consumer account (146). The acquirer processor (147) is to receive the funds on behalf of the merchant account (148). The issuer processor (145) and the acquirer processor (147) communicate with the transaction handler (103) to coordinate the transfer of funds for the transaction. The funds can be transferred electronically.

The transaction terminal (105) may submit a transaction directly for settlement, without having to separately submit an authorization request.

In one embodiment, the portal (143) provides a user interface to allow the user (101) to organize the transactions in one or more consumer accounts (146) of the user with one or more issuers. The user (101) may organize the transactions using information and/or categories identified in the transaction records, such as merchant category, transaction date, amount, etc. Examples and techniques in one embodiment are provided in U.S. Pat. App. Pub. No. 2007/0055597, entitled “Method and System for Manipulating Purchase Information,” the disclosure of which is hereby incorporated herein by reference.

### Transaction Terminal

FIG. 5 illustrates a transaction terminal according to one embodiment. The transaction terminal (105) illustrated in FIG. 5 can be used in various systems discussed in connection with other figures of the present disclosure. In FIG. 5, the transaction terminal (105) is configured to interact with an account identification device (141) to obtain account information (142) about the consumer account (146).

In one embodiment, the transaction terminal (105) includes a memory (167) coupled to the processor (151), which controls the operations of a reader (163), an input device (153), an output device (165) and a network interface (161). The memory (167) may store instructions for the processor (151) and/or data, such as an identification that is associated with the merchant account (148).

In one embodiment, the reader (163) includes a magnetic strip reader. In another embodiment, the reader (163) includes a contactless reader, such as a radio frequency identification (RFID) reader, a near field communications (NFC) device configured to read data via magnetic field coupling (in accordance with ISO standard 14443/NFC), a Bluetooth transceiver, a WiFi transceiver, an infrared transceiver, a laser scanner, etc.

In one embodiment, the input device (153) includes key buttons that can be used to enter the account information (142) directly into the transaction terminal (105) without the physical presence of the account identification device (141). The input device (153) can be configured to provide further information to initiate a transaction, such as a personal identification number (PIN), password, zip code, etc. that may be used to access the account identification device (141), or in combination with the account information (142) obtained from the account identification device (141).

In one embodiment, the output device (165) may include a display, a speaker, and/or a printer to present information, such as the result of an authorization request, a receipt for the transaction, an advertisement, etc.

In one embodiment, the network interface (161) is configured to communicate with the acquirer processor (147) via a telephone connection, an Internet connection, or a dedicated data communication channel.

In one embodiment, the instructions stored in the memory (167) are configured at least to cause the transaction terminal (105) to send an authorization request message to the acquirer processor (147) to initiate a transaction. The transaction terminal (105) may or may not send a separate request for the clearing and settling of the transaction. The instructions stored in the memory (167) are also configured to cause the transaction terminal (105) to perform other types of functions discussed in this description.

In one embodiment, a transaction terminal (105) may have fewer components than those illustrated in FIG. 5. For example, in one embodiment, the transaction terminal (105) is configured for “card-not-present” transactions; and the transaction terminal (105) does not have a reader (163).

In one embodiment, a transaction terminal (105) may have more components than those illustrated in FIG. 5. For example, in one embodiment, the transaction terminal (105) is an ATM machine, which includes components to dispense cash under certain conditions.

### Account Identification Device

FIG. 6 illustrates an account identifying device according to one embodiment. In FIG. 6, the account identification device (141) is configured to carry account information (142) that identifies the consumer account (146).

In one embodiment, the account identification device (141) includes a memory (167) coupled to the processor (151), which controls the operations of a communication device (159), an input device (153), an audio device (157) and a display device (155). The memory (167) may store instructions for the processor (151) and/or data, such as the account information (142) associated with the consumer account (146).

In one embodiment, the account information (142) includes an identifier identifying the issuer (and thus the issuer processor (145)) among a plurality of issuers, and an identifier identifying the consumer account among a plurality of consumer accounts controlled by the issuer processor (145). The account information (142) may include an expiration date of the account identification device (141), the name of the consumer holding the consumer account (146), and/or an identifier identifying the account identification device (141) among a plurality of account identification devices associated with the consumer account (146).

In one embodiment, the account information (142) may further include a loyalty program account number, accumulated rewards of the consumer in the loyalty program, an address of the consumer, a balance of the consumer account (146), transit information (e.g., a subway or train pass), access information (e.g., access badges), and/or consumer information (e.g., name, date of birth), etc.

In one embodiment, the memory includes a nonvolatile memory, such as magnetic strip, a memory chip, a flash memory, a Read Only Memory (ROM), etc. to store the account information (142).

In one embodiment, the information stored in the memory (167) of the account identification device (141) may also be in the form of data tracks that are traditionally associated with credits cards. Such tracks include Track 1 and Track 2. Track 1 (“International Air Transport Association”) stores more information than Track 2, and contains the cardholder's name as well as the account number and other discretionary data. Track 1 is sometimes used by airlines when securing reservations with a credit card. Track 2 (“American Banking Association”) is currently most commonly used and is read by ATMs and credit card checkers. The ABA (American Banking Association) designed the specifications of Track 1 and banks abide by it. It contains the cardholder's account number, encrypted PIN, and other discretionary data.

In one embodiment, the communication device (159) includes a semiconductor chip to implement a transceiver for communication with the reader (163) and an antenna to provide and/or receive wireless signals.

In one embodiment, the communication device (159) is configured to communicate with the reader (163). The communication device (159) may include a transmitter to transmit the account information (142) via wireless transmissions, such as radio frequency signals, magnetic coupling, or infrared, Bluetooth or WiFi signals, etc.

In one embodiment, the account identification device (141) is in the form of a mobile phone, personal digital assistant (PDA), etc. The input device (153) can be used to provide input to the processor (151) to control the operation of the account identification device (141); and the audio device (157) and the display device (155) may present status information and/or other information, such as advertisements or offers. The account identification device (141) may include further components that are not shown in FIG. 6, such as a cellular communications subsystem.

In one embodiment, the communication device (159) may access the account information (142) stored on the memory (167) without going through the processor (151).

In one embodiment, the account identification device (141) has fewer components than those illustrated in FIG. 6. For example, an account identification device (141) does not have the input device (153), the audio device (157) and the display device (155) in one embodiment; and in another embodiment, an account identification device (141) does not have components (151-159).

For example, in one embodiment, an account identification device (141) is in the form of a debit card, a credit card, a smartcard, or a consumer device that has optional features such as magnetic strips, or smartcards.

An example of an account identification device (141) is a magnetic strip attached to a plastic substrate in the form of a card. The magnetic strip is used as the memory (167) of the account identification device (141) to provide the account information (142). Consumer information, such as account number, expiration date, and consumer name may be printed or embossed on the card. A semiconductor chip implementing the memory (167) and the communication device (159) may also be embedded in the plastic card to provide account information (142) in one embodiment. In one embodiment, the account identification device (141) has the semiconductor chip but not the magnetic strip.

In one embodiment, the account identification device (141) is integrated with a security device, such as an access card, a radio frequency identification (RFID) tag, a security card, a transponder, etc.

In one embodiment, the account identification device (141) is a handheld and compact device. In one embodiment, the account identification device (141) has a size suitable to be placed in a wallet or pocket of the consumer.

Some examples of an account identification device (141) include a credit card, a debit card, a stored value device, a payment card, a gift card, a smartcard, a smart media card, a payroll card, a health care card, a wrist band, a keychain device, a supermarket discount card, a transponder, and a machine readable medium containing account information (142).

### Point of Interaction

In one embodiment, the point of interaction (107) is to provide an advertisement to the user (101), or to provide information derived from the transaction data (109) to the user (101).

In one embodiment, an advertisement is a marketing interaction which may include an announcement and/or an offer of a benefit, such as a discount, incentive, reward, coupon, gift, cash back, or opportunity (e.g., special ticket/admission). An advertisement may include an offer of a product or service, an announcement of a product or service, or a presentation of a brand of products or services, or a notice of events, facts, opinions, etc. The advertisements can be presented in text, graphics, audio, video, or animation, and as printed matter, web content, interactive media, etc. An advertisement may be presented in response to the presence of a financial transaction card, or in response to a financial transaction card being used to make a financial transaction, or in response to other user activities, such as browsing a web page, submitting a search request, communicating online, entering a wireless communication zone, etc. In one embodiment, the presentation of advertisements may be not a result of a user action.

In one embodiment, the point of interaction (107) can be one of various endpoints of the transaction network, such as point of sale (POS) terminals, automated teller machines (ATMs), electronic kiosks (or computer kiosks or interactive kiosks), self-assist checkout terminals, vending machines, gas pumps, websites of banks (e.g., issuer banks or acquirer banks of credit cards), bank statements (e.g., credit card statements), websites of the transaction handler (103), websites of merchants, checkout websites or web pages for online purchases, etc.

In one embodiment, the point of interaction (107) may be the same as the transaction terminal (105), such as a point of sale (POS) terminal, an automated teller machine (ATM), a mobile phone, a computer of the user for an online transaction, etc. In one embodiment, the point of interaction (107) may be co-located with, or near, the transaction terminal (105) (e.g., a video monitor or display, a digital sign), or produced by the transaction terminal (e.g., a receipt produced by the transaction terminal (105)). In one embodiment, the point of interaction (107) may be separate from and not co-located with the transaction terminal (105), such as a mobile phone, a personal digital assistant, a personal computer of the user, a voice mail box of the user, an email inbox of the user, a digital sign, etc.

For example, the advertisements can be presented on a portion of media for a transaction with the customer, which portion might otherwise be unused and thus referred to as a “white space” herein. A white space can be on a printed matter (e.g., a receipt printed for the transaction, or a printed credit card statement), on a video display (e.g., a display monitor of a POS terminal for a retail transaction, an ATM for cash withdrawal or money transfer, a personal computer of the customer for online purchases), or on an audio channel (e.g., an interactive voice response (IVR) system for a transaction over a telephonic device).

In one embodiment, the white space is part of a media channel available to present a message from the transaction handler (103) in connection with the processing of a transaction of the user (101). In one embodiment, the white space is in a media channel that is used to report information about a transaction of the user (101), such as an authorization status, a confirmation message, a verification message, a user interface to verify a password for the online use of the account information (142), a monthly statement, an alert or a report, or a web page provided by the portal (143) to access a loyalty program associated with the consumer account (146) or a registration program.

In other embodiments, the advertisements can also be presented via other media channels which may not involve a transaction processed by the transaction handler (103). For example, the advertisements can be presented on publications or announcements (e.g., newspapers, magazines, books, directories, radio broadcasts, television, digital signage, etc., which may be in an electronic form, or in a printed or painted form). The advertisements may be presented on paper, on websites, on billboards, on digital signs, or on audio portals.

In one embodiment, the transaction handler (103) purchases the rights to use the media channels from the owner or operators of the media channels and uses the media channels as advertisement spaces. For example, white spaces at a point of interaction (e.g., 107) with customers for transactions processed by the transaction handler (103) can be used to deliver advertisements relevant to the customers conducting the transactions; and the advertisement can be selected based at least in part on the intelligence information derived from the accumulated transaction data (109) and/or the context at the point of interaction (107) and/or the transaction terminal (105).

In general, a point of interaction (e.g., 107) may or may not be capable of receiving inputs from the customers, and may or may not co-located with a transaction terminal (e.g., 105) that initiates the transactions. The white spaces for presenting the advertisement on the point of interaction (107) may be on a portion of a geographical display space (e.g., on a screen), or on a temporal space (e.g., in an audio stream).

In one embodiment, the point of interaction (107) may be used to primarily to access services not provided by the transaction handler (103), such as services provided by a search engine, a social networking website, an online marketplace, a blog, a news site, a television program provider, a radio station, a satellite, a publisher, etc.

In one embodiment, a consumer device is used as the point of interaction (107), which may be a non-portable consumer device or a portable computing device. The consumer device is to provide media content to the user (101) and may receive input from the user (101).

Examples of non-portable consumer devices include a computer terminal, a television set, a personal computer, a set-top box, or the like. Examples of portable consumer devices include a portable computer, a cellular phone, a personal digital assistant (PDA), a pager, a security card, a wireless terminal, or the like. The consumer device may be implemented as a data processing system as illustrated in FIG. 7, with more or fewer components.

In one embodiment, the consumer device includes an account identification device (141). For example, a smart card used as an account identification device (141) is integrated with a mobile phone, or a personal digital assistant (PDA).

In one embodiment, the point of interaction (107) is integrated with a transaction terminal (105). For example, a self-service checkout terminal includes a touch pad to interact with the user (101); and an ATM machine includes a user interface subsystem to interact with the user (101).

### Hardware

In one embodiment, a computing apparatus is configured to include some of the computer systems illustrated in various figures, such as the transaction handler (103), the profile generator (121), the media controller (115), the portal (143), the profile selector (129), the advertisement selector (133), the user tracker (113), the correlator, and their associated storage devices, such as the data warehouse (149).

In one embodiment, at least some of the computer systems such as the transaction handler (103), the transaction terminal (105), the point of interaction (107), the user tracker (113), the media controller (115), the correlator (117), the profile generator (121), the profile selector (129), the advertisement selector (133), the portal (143), the issuer processor (145), the acquirer processor (147), and the account identification device (141), can be implemented as a data processing system (170) illustrated in FIG. 7. Some of the components may share hardware or be combined on a computer system. In one embodiment, a network of computers can be used to implement one or more of the components.

Further, the data illustrated in the figures, such as transaction data (109), account data (111), transaction profiles (127), and advertisement data (135), can be stored in storage devices of one or more computers accessible to the corresponding components. For example, the transaction data (109) can be stored in the data warehouse (149) that can be implemented as a data processing system illustrated in FIG. 7, with more or fewer components.

In one embodiment, the transaction handler (103) is a payment processing system, or a payment card processor, such as a card processor for credit cards, debit cards, etc.

FIG. 7 illustrates a data processing system according to one embodiment. While FIG. 7 illustrates various components of a computer system, it is not intended to represent any particular architecture or manner of interconnecting the components. One embodiment may use other systems that have fewer or more components than those shown in FIG. 7.

In FIG. 7, the data processing system (170) includes an inter-connect (171) (e.g., bus and system core logic), which interconnects a microprocessor(s) (173) and memory (167). The microprocessor (173) is coupled to cache memory (179) in the example of FIG. 7.

In one embodiment, the inter-connect (171) interconnects the microprocessor(s) (173) and the memory (167) together and also interconnects them to input/output (I/O) device(s) (175) via I/O controller(s) (177). I/O devices (175) may include a display device and/or peripheral devices, such as mice, keyboards, modems, network interfaces, printers, scanners, video cameras and other devices known in the art. In one embodiment, when the data processing system is a server system, some of the I/O devices (175), such as printers, scanners, mice, and/or keyboards, are optional.

In one embodiment, the inter-connect (171) includes one or more buses connected to one another through various bridges, controllers and/or adapters. In one embodiment the I/O controllers (177) include a USB (Universal Serial Bus) adapter for controlling USB peripherals, and/or an IEEE-1394 bus adapter for controlling IEEE-1394 peripherals.

In one embodiment, the memory (167) includes one or more of: ROM (Read Only Memory), volatile RAM (Random Access Memory), and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In this description, some functions and operations are described as being performed by or caused by software code to simplify description. However, such expressions are also used to specify that the functions result from execution of the code/instructions by a processor, such as a microprocessor.

Alternatively, or in combination, the functions and operations as described here can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While one embodiment can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The computer-readable media may store the instructions.

The instructions may also be embodied in digital and analog communication links for electrical, optical, acoustical or other forms of propagated signals, such as carrier waves, infrared signals, digital signals, etc. However, propagated signals, such as carrier waves, infrared signals, digital signals, etc. are not tangible machine readable medium and are not configured to store instructions.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

### Other Aspects

The description and drawings are illustrative and are not to be construed as limiting. The present disclosure is illustrative of inventive features to enable a person skilled in the art to make and use the techniques. Various features, as described herein, should be used in compliance with all current and future rules, laws and regulations related to privacy, security, permission, consent, authorization, and others. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

The use of headings herein is merely provided for ease of reference, and shall not be interpreted in any way to limit this disclosure or the following claims.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, and are not necessarily all referring to separate or alternative embodiments mutually exclusive of other embodiments. Moreover, various features are described which may be exhibited by one embodiment and not by others. Similarly, various requirements are described which may be requirements for one embodiment but not other embodiments. Unless excluded by explicit description and/or apparent incompatibility, any combination of various features described in this description is also included here. For example, the features described above in connection with “in one embodiment” or “in some embodiments” can be all optionally included in one implementation, except where the dependency of certain features on other features, as apparent from the description, may limit the options of excluding selected features from the implementation, and incompatibility of certain features with other features, as apparent from the description, may limit the options of including selected features together in the implementation.

The disclosures of the above discussed patent documents are hereby incorporated herein by reference.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A computing apparatus, comprising:
a processing system configured to process a predetermined type of operations using a predetermined communication protocol on a first network connecting a first terminal in a first geographical region and a first resource controller in a second geographical region;
a communication portal configured to communicate with a plurality of mobile devices using a second network independent of communications of the processing system in the first network for the predetermined type of operations; and
a data store coupled with the processing system;
wherein in response to the computing apparatus detecting an activity of a first mobile device of the plurality of mobile devices in connection with the first geographical region, the communication portal communicates via the second network with the first mobile device to establish, in the data store, a resource correlation record associating a first resource controlled by the first resource controller in the second geographical region with a second resource, wherein the resource correlation record includes locale dependent parameters;
wherein in response to the processing system detecting in the first network using the resource correlation record, a first communication initiated in the first terminal using the predetermined communication protocol for a first operation of the predetermined type using the first resource, the processing system applies the second resource to the first operation in accordance with the resource correlation record using at least the locale dependent parameters.

2. The computing apparatus of claim 1, wherein the activity of the first mobile device in connection with the first geographical region is detected using a location determination device integrated in the first mobile device.

3. The computing apparatus of claim 1, wherein the activity of the first mobile device in connection with the first geographical region is detected based on a communication communicated using the predetermined communication protocol in the first network.

4. A method, comprising:
providing a computing apparatus, comprising:
a processing system configured to process a predetermined type of operations using a predetermined communication protocol on a first network connecting a first terminal in a first geographical region and a first resource controller in a second geographical region;
a communication portal configured to communicate with a plurality of mobile devices using a second network independent of communications of the processing system in the first network for the predetermined type of operations; and
a data store coupled with the processing system;
detecting, by the computing apparatus, an activity of a first mobile device of the plurality of mobile devices in connection with the first geographical region;
in response to the activity being detected, communicating, by the communication portal via the second network with the first mobile device;
establishing, in the data store via the communicating, a resource correlation record associating a first resource controlled by the first resource controller in the second geographical region with a second resource, wherein the resource correlation record includes locale dependent parameters;
detecting, by the processing system in the first network using the resource correlation record, a first communication initiated in the first terminal using the predetermined communication protocol for a first operation of the predetermined type using the first resource; and
in response to the detecting, applying, by the processing system, the second resource to the first operation in accordance with the resource correlation record using at least the locale dependent parameters.

5. The method of claim 4, wherein the first mobile device includes a position determination device to determine a current location of the first mobile device and a mobile application configured to initiate a communication with the communication portal in response to a determination that the first mobile device has entered the first region.

6. The method of claim 4, wherein the first network further connects a second terminal in the first geographical region; and the detecting of the activity in connection with the first geographical region comprises:
detecting, by the processing system in the first network, a second communication initiated in the second terminal using the predetermined communication protocol for a second operation of the predetermined type using the first resource.

7. The method of claim 6, further comprising:
storing in the data store a record associating a communication reference of the first mobile device and an identification of the first resource;
wherein, in response to the detecting of the second communication, from the second terminal disposed in the first geographical region, the communication portal uses the communication reference of the first mobile device associated with the identification of the first resource to communicate with the first mobile device and establish the resource correlation record.

8. The method of claim 7, wherein the communicating, by the communication portal via the second network with the first mobile device in response to the activity being detected, comprises:
communicating availability of the second resource from the communication portal to the first mobile device.

9. The method of claim 7, wherein the communicating, by the communication portal via the second network with the first mobile device in response to the activity being detected, comprises:
receiving, by the communication portal from the first mobile device, an instruction to create the resource correlation record.

10. The method of claim 4, wherein the first network is an electronic payment processing network; and the processing system comprises a transaction handler configured in the electronic payment processing network.

11. The method of claim 10, wherein the transaction handler is configured in the electronic payment processing network to interconnect issuer processors controlling first accounts from which payments are made and acquirer processors controlling second accounts to which the payments are made.

12. The method of claim 11, wherein the first communication includes an authorization request for a payment transaction in a payment account controlled by the first resource controller as an issuer processor in the electronic payment processing network; and the second resource includes a benefit of an offer applicable to the payment transaction.

13. The method of claim 12, wherein the benefit is dependent on a transaction amount of the payment transaction in a first currency local to the first region in which the first terminal is located; and the benefit is specified in a second currency local to the second geographical region in which the first resource controller is located.

14. The method of claim 13, further comprising, in response to the authorization request:
identifying, by the transaction handler from the authorization request, a first transaction amount in the first currency;
determining, by the transaction handler, an exchange rate between the first currency and the second currency; and
computing, by the transaction handler, a second transaction amount in the second currency;
applying, by the transaction handler, the benefit of the offer based on the first transaction amount in the first currency and the second transaction amount in the second currency.

15. The method of claim 14, wherein the benefit is applied when the first transaction amount is above a threshold specified by the offer; and the benefit is computed based upon the second transaction amount.

16. The method of claim 14, wherein the applying of the benefit of the offer comprises:
communicating by the transaction handler a communication the electronic payment processing network to the issuer processor to cause the issuer processor to apply a statement credit to the payment account as the benefit of the offer.

17. The method of claim 14, wherein the applying of the benefit of the offer comprises:
computing a third transaction amount for the payment transaction in the second currency by reducing the benefit of the offer from the second transaction amount;
modifying the authorization request to generate a modified authorization request by replacing the first transaction amount in the first currency with the third transaction amount in the second currency;
communicating by the transaction handler in electronic payment processing network the modified authorization request to the issuer processor.

18. The method of claim 17, further comprising:
in response to the authorization request, communicating by the transaction handler in electronic payment processing network with a sponsor processor controlling the benefit of the offer for authorization of applying the benefit of the offer to the payment transaction.

19. The method of claim 12, wherein the detecting of the activity in connection with the first geographical region comprises:
detecting a payment transaction in the payment account for a purchase of a transportation arrangement having a destination in the first geographical region.

20. A non-transitory computer storage medium storing instructions configured to instruct a computing apparatus to perform a method, the method comprising:
providing a computing apparatus, comprising:
a processing system configured to process a predetermined type of operations using a predetermined communication protocol on a first network connecting a first terminal in a first geographical region and a first resource controller in a second geographical region;
a communication portal configured to communicate with a plurality of mobile devices using a second network independent of communications of the processing system in the first network for the predetermined type of operations; and
a data store coupled with the processing system;
detecting, by the computing apparatus, an activity of a first mobile device of the plurality of mobile devices in connection with the first geographical region;
in response to the activity being detected, communicating, by the communication portal via the second network with the first mobile device;
establishing, in the data store via the communicating, a resource correlation record associating a first resource controlled by the first resource controller in the second geographical region with a second resource, wherein the resource correlation record includes locale dependent parameters;
detecting, by the processing system in the first network using the resource correlation record, a first communication initiated in the first terminal using the predetermined communication protocol for a first operation of the predetermined type using the first resource; and
in response to the detecting, applying, by the processing system, the second resource to the first operation in accordance with the resource correlation record using at least the locale dependent parameters.
